(19) United States
(12) Patent Application Publication
(10) Pub. No.: US 2022/0108272 A1
(43) Pub. Date: Apr. 7, 2022

(54) Parcel Margin Optimization (PMO) System for and Methods of Generating and Optimizing Discounted Parcel Shipping Prices

(71) Applicant: TransImpact, LLC, Emerald Isle, NC (US)

(72) Inventor: Norman Pollock, Emerald Isle, NC (US)

(73) Assignee: TransImpact, LLC, Emerald Isle, NC (US)

(21) Appl. No.: 17/494,570

(22) Filed: Oct. 5, 2021

Related U.S. Application Data
(60) Provisional application No. 63/087,950, filed on Oct. 6, 2020.

(51) Int. Cl. G06Q 10/08

(52) U.S. Cl. CPC G06Q 10/08345; G06Q 10/0838

(57) ABSTRACT

A system and method of generating discounted parcel shipping rates. The system and method may include a computing device configured to receive historical shipping data of a potential/current client of a logistics service provider; determine historical shipping rates for historical parcel shipments charged to the potential or current client by one or more shipping carriers based on the received historical shipping data; compare the determined historical shipping rate to a discounted shipping rate charged to the logistics service provider by the one or more shipping carriers for a same or comparable shipping service; and determine a discounted shipping rate to offer the potential or current client based in part on the comparison of the determined potential or current client historical shipping rate and the discounted shipping rate charged to the logistics service provider by the one or more shipping carriers for the same or comparable shipping service.

### RELATED APPLICATIONS

This application is related and claims priority to U.S. Provisional Patent Application No.: 63/087,950, filed on Oct. 6, 2020, the application of which is incorporate herein by reference in its entirety.

### TECHNICAL FIELD

The subject matter of the invention relates generally to a system and method for optimizing and generating shipping prices, and more particularly to a parcel margin optimization (PMO) system for and methods of generating discounted parcel shipping rates to optimizing margins.

### BACKGROUND

Currently, there are companies that warehouse and ship products on behalf of clients, referred to as third-party logistics (3PL) companies. Typically, a 3PL company holds clients' products at 3PL-owned facilities and ships the products as instructed by the client or the client's customers. Many 3PL companies generate some revenue by adding a handling fee to the shipping fees charged to the 3PL by the shipping company or courier. Also, 3PL companies often pay reduced shipping rates because the 3PL may aggregate clients' shipping to receive high volume discounts. Thus, 3PL companies often pay significantly discounted shipping rates compared to the rates that individual clients would pay.

After shipping, the 3PL bills the client for all costs—shipping fees charged by the carrier and the 3PL handling fee. This results in an invoice that openly shows the fees charged by the 3PL and the shipping rate charged to the 3PL by the carrier. This may cause a problem as some customers may complain at the fee charged by the 3PL versus what the 3PL is being charged by the carrier. For example, large clients may push back at the 3PL's fees and demand that they not be charged any markup over that which the carrier is charging the 3PL. Accordingly, new approaches are needed with respect to optimizing the 3PL company's parcel shipping margins.

### SUMMARY

In one embodiment, a parcel margin optimization (PMO) system for generating discounted parcel shipping rates is provided. The system may include at least one computing device capable of processing program instructions; and at least one storage device operable coupled to the at least one computing device. The at least one storage device may include program instructions that, when executed by the at least one computing device cause the at least one computing device to receive historical shipping data of a potential or current client of a logistics service provider; determine at least one historical shipping rate for one or more historical parcel shipments charged to the potential or current client by one or more shipping carriers based on the received historical shipping data; compare the at least one determined historical shipping rate to a discounted shipping rate charged to the logistics service provider by the one or more shipping carriers for a same or comparable shipping service; and determine a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service. The computing device may be further configured to determine an estimated savings over a period of time for the potential or current client over the at least one determined historical shipping rate based on the determined potential or current client discounted shipping rate. The potential or current client discounted shipping rate is less than the at least one determined potential or current client historical shipping rate and greater than or equal to the discounted shipping rate charged to the logistics service provider by the one or more shipping carriers for the same or comparable shipping service. The at least one storage device may further include data related to one or more of current clients, potential clients, shipping rate data, shipping carriers, shipment data, and the logistic service provider. The one or more of the at least one computing device may include a user interface, wherein the system may be accessed by either or both of the potential or current client and logistics service provider via the user interface, and wherein the potential or current client may access a client side of the system and the logistics service provider may access a service provider side of the system. The at least one computing device may be connected via a network to one or more of one or more potential or current clients, one or more shipping carriers, and one or more logistic service providers. The logistics service provider may include a fulfillment provider or any other entity that provides third-party logistics services. The determined potential or current client discounted shipping rate may be further based on any one or more of shipping location, shipping carrier, and level of shipping service. The offered potential or current client discounted shipping rate may be represented to the potential or current client as a discounted rate relative to the determined potential or current client historical shipping rate. The computing device may be further configured to generate a client invoice for shipping one or more parcels, and wherein the client invoice shows a shipping rate as a discounted shipping rate over the determined historical shipping rate or a published shipping rate of the shipping carrier, and further wherein an amount of the shipping rate actually paid by the logistics service provide to the shipping carrier for shipping the one or more parcels is not visible to the potential or current client. The historical shipping data may include cost data for one or more historical parcel shipments charged to the potential or current client by one or more shipping carriers and/or the one or more shipping carriers' published shipping rates. The computing device may be further configured to generate a client report for a client of the logistics service provider, wherein the client report may include one or more of shipping details, costs, and savings for one or more parcels shipped using the logistics service provider over a defined period of time. The computing device may be further configured to generate a client side dashboard accessible by a client of the logistics service provider, wherein the client side dashboard allows client access to business information and analytics related to the client's shipping costs for logistic services provided by the logistics service provider. The information displayed in the client side dashboard may utilize, for example, the values calculated by system based on the discount structure (discounted shipping rates) provided by the logistics service provider to the client, and may further correctly rate any credits it displays, not just the initial charges. The client side dashboard may be a separate add on application and may be configured to access the at least one storage device to access the applicable data stored therein to generate the client side dashboard with the client's business information and analytics.

In another embodiment, a method for generating optimized discounted parcel shipping rates. The method may include one or more of receiving historical shipping data of a potential or current client of a logistics service provider; determining at least one historical shipping rate for one or more historical parcel shipments charged to the potential or current client by one or more shipping carriers based on the received historical shipping data; comparing the at least one determined historical shipping rate to a discounted shipping rate charged to the logistics service provider by the one or more shipping carriers for a same or comparable shipping service; and determining a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service. The method may further include determining an estimated cost over a period of time for the potential or current client based on the at least one determined historical shipping rate. The may further include determining an estimated savings over a period of time for the potential or current client over the at least one determined historical shipping rate based on the determined potential or current client discounted shipping rate. The potential or current client discounted shipping rate is less than the at least one determined potential or current client historical shipping rate and greater than or equal to the discounted shipping rate charged to the logistics service provider by the one or more shipping carriers for the same or comparable shipping service. Determining potential or current client discounted shipping rate may be further based on any one or more of shipping location, shipping carrier, and level of shipping service. The offered potential or current client discounted shipping rate may be represented to the potential or current client as a discounted rate relative to the determined potential or current client historical shipping rate. The method may further include generating a client invoice for shipping one or more parcels, and wherein the client invoice shows a shipping rate as a discounted shipping rate over the determined historical shipping rate or a published shipping rate of the shipping carrier, and further wherein an amount of the shipping rate actually paid by the logistics service provide to the shipping carrier for shipping the one or more parcels is not visible to the potential or current client. The method may further include repeating the method one or more times until a desired optimized level of potential or current client discounted shipping rate and logistics service provider margin is achieved.

In yet another embodiment, a computer readable storage medium storing a program of instructions executable by a machine to perform a method of generating optimized discounted parcel shipping rates is provided. The method may include receiving historical shipping data of a potential or current client of a logistics service provider; determining at least one historical shipping rate for one or more historical parcel shipments charged to the potential or current client by one or more shipping carriers based on the received historical shipping data; comparing the at least one determined historical shipping rate to a discounted shipping rate charged to the logistics service provider by the one or more shipping carriers for a same or comparable shipping service; and determining a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example PMO system for generating and optimizing discounted parcel shipping prices in accordance with an embodiment of the invention;

FIGS. 2 and 3 illustrate examples of user interface panels of the PMO system shown in FIG. 1 in accordance with embodiments of the invention;

FIG. 4 illustrates an example of various revenue models comparing various percent markups in accordance with an embodiment of the invention;

FIG. 5 illustrates an example detailed client report in accordance with an embodiment of the invention;

FIG. 6 illustrates an example 3PL client audit dashboard in accordance with an embodiment of the invention;

FIG. 7 illustrates a generalized flow diagram of an example method of using the PMO system for generating and optimizing discounted parcel shipping prices in accordance with embodiments of the invention; and

FIG. 8A and FIG. 8B illustrates a flow diagram of an example method of using the PMO system for generating and optimizing discounted parcel shipping prices in accordance with embodiments of the invention.

### DETAILED DESCRIPTION

The subject matter of the invention now will be described more fully hereinafter with reference to the accompanying drawings, in which some, but not all embodiments of the invention are shown. Like numbers refer to like elements throughout. The invention may be embodied in many different forms and should not be construed as limited to the embodiments set forth herein; rather, these embodiments are provided so that this disclosure will satisfy applicable legal requirements. Indeed, many modifications and other embodiments of the invention set forth herein will come to mind to one skilled in the art to which the invention pertains having the benefit of the teachings presented in the foregoing descriptions and the associated Drawings. Therefore, it is to be understood that the invention is not to be limited to the specific embodiments disclosed and that modifications and other embodiments are intended to be included within the scope of the appended claims.

In some embodiments, the invention provides a parcel margin optimization (PMO) system for and methods of generating and optimizing discounted parcel shipping prices to optimize a third-party logistics (3PL) company's parcel shipping margins.

In some embodiments, the PMO system and method may be provided and operated by a 3PL service provider and wherein the PMO system may include a networked computing device further including a PMO application, certain PMO client data, and certain shipping carrier data. Additionally, the PMO system may be used to manage a plurality of, for example, E-commerce merchants and a plurality of shipping carriers, who may also be connected to the network. Further, the PMO system and method may be provided/hosted by a third-party where the 3PL service provider has access to the third-party provided/hosted PMO system.

In some embodiments, the PMO system and method provides a system for a 3PL company to determine a discounted shipping rate paid for a client, and to generate invoices that charge clients an appropriate shipping rate and with a certain markup for each client that optimizes the 3PL's parcel shipping margin.

In some embodiments, the PMO system and method provides a system for a 3PL company to offer rates to clients that match the same method as a parcel or freight carrier.

In some embodiments, the PMO system and method provides a system for a 3PL company to quickly and automatically generate invoices to send to each client after a client's products have been shipped from a 3PL facility.

In some embodiments, the PMO system and method provides a system for a 3PL company to change client pricing from marking up 3PL net rates to specific discounts by service off the carrier published rates.

In some embodiments, the PMO system and method provides a full featured system to calculate and manage client rates.

In some embodiments, the PMO system and method provides a means for a 3PL company to develop multiple IT foundational components to deploy, support, and maintain a parcel margin optimizer.

In some embodiments, the PMO system and method provides a custom invoice tool, which provides a flexible and creative invoicing solution to serve client accountability requirements.

In some embodiments, the PMO system and method provides innovative pricing and reporting tools built using a proprietary parcel technology platform.

In some embodiments, the PMO system and method provides a client-facing spend trend dashboard, which provides clients access to business intelligence and minimizes the 3PLs own IT investment while strengthening business offering and margin contribution.

In some embodiments, the benefits of the PMO system and method may include, but are not limited to, increased profitability compared with mark-up plan; differentiate a 3PL company from its competitors; provides the client with optimal shipping location to maximize their savings; allows 3PL to adjust client savings to the level required to obtain the business; may eliminate negative client perceptions with mark-up negotiations; may eliminate internal labor requirement to administer discount plan; provides the client with a self-service, customized dashboard for flexible, detailed reporting; and provides a way to manage and report on profitability at the client level.

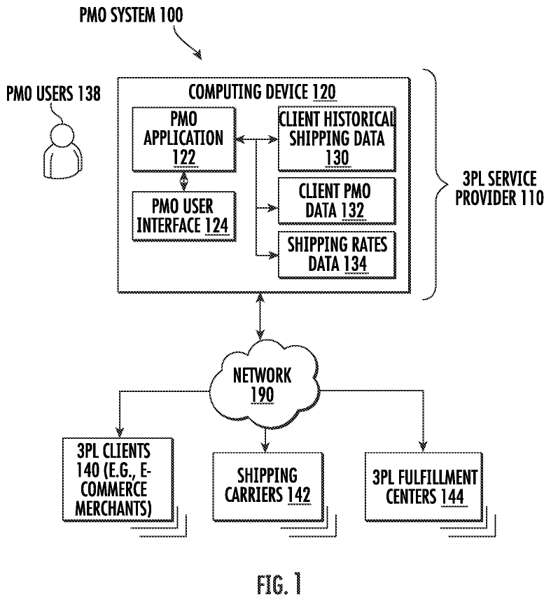

Referring now to FIG. 1 is a block diagram of an example of a PMO system 100 for generating and optimizing discounted parcel shipping prices to optimize a 3PL company's parcel shipping margins. PMO system 100 may include a 3PL service provider 110 that provides a PMO application 122 installed and operating on a computing device 120. PMO application 122 may be a software or hardware application or algorithm for managing the overall operations of PMO system 100. PMO system 100 may be used to optimize discounted parcel shipping prices to further optimize the parcel shipping margins of 3PL service provider 110. 3PL service provider 110 may be any 3PL company that provides 3PL services to, for example, one or more 3PL clients 140, e.g., E-commerce merchants.

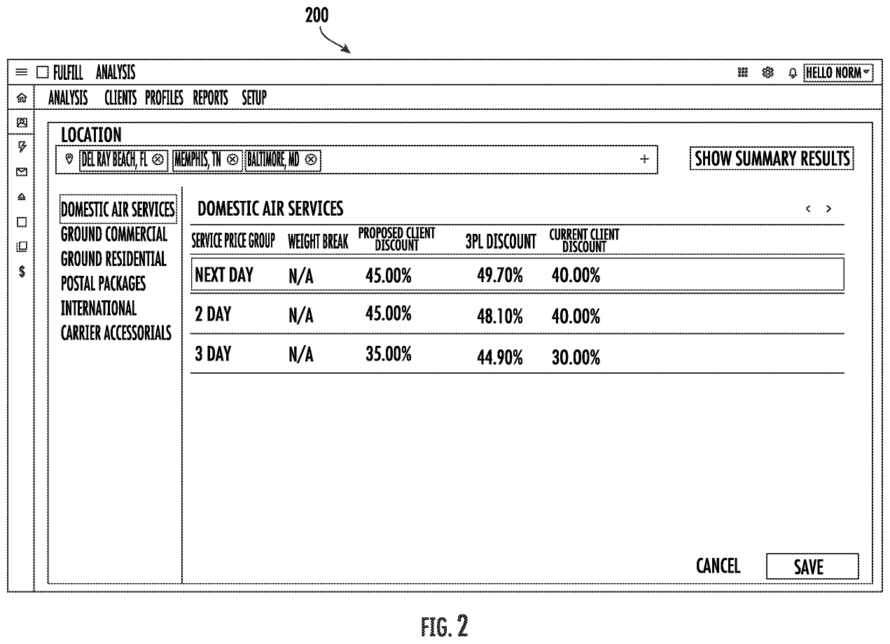

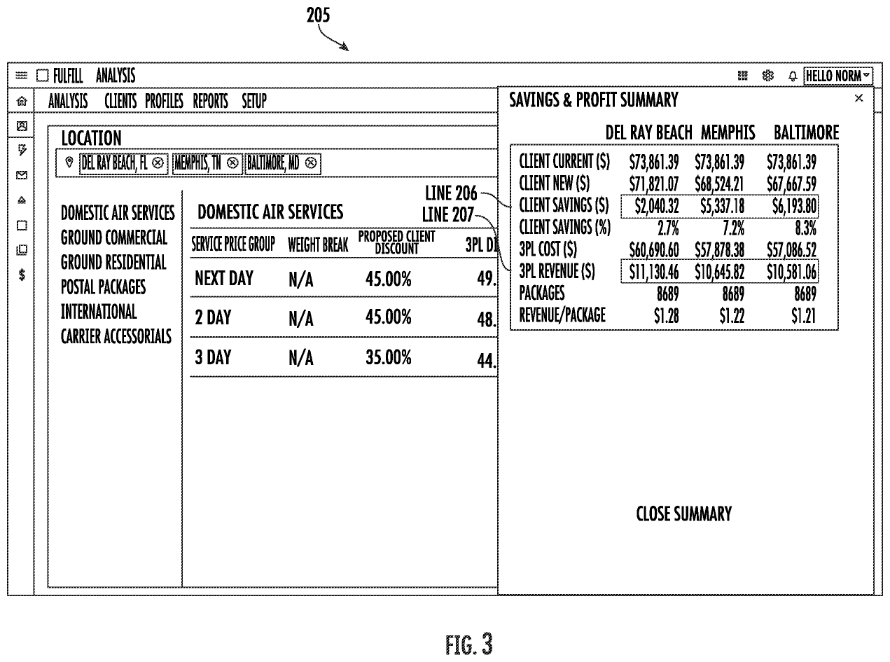

PMO application 122 may have a corresponding PMO user interface 124. For example, one or more PMO users 138 may interact with PMO application 122 using PMO user interface 124 (see FIGS. 2 and 3). A PMO user 138 may be, for example, a sales associate of 3PL service provider 110. Further, PMO application 122 processes certain information stored on or available to computing device 120. For example, computing device 120 may include, but is not limited to, client historical shipping data 130, client PMO data 132, and shipping rates data 134.

Further, PMO system 100 may include a network 190 for connecting computing device 120 with, for example, one or more 3PL clients 140, 3PL fulfillment centers 144, and/or one or more shipping carriers 142 (e.g., any ground and/or air carriers). For example, network 190 may be any wide area network (WAN), local area network (LAN), and/or any other suitable network system. Computing device 120 may be any computing device capable of processing program instructions and capable of connecting to a network. For example, computing device 120 may be a desktop computer, a laptop computer, a tablet device, a mobile phone or smartphone, a smartwatch, an application server, a cloud computing device, cloud server in a cloud computing environment, and/or any other suitable computing device.

Referring now to FIGS. 2 and 3 are non-limiting examples of display panels of PMO user interface 124 of PMO application 122 of the PMO system 100 shown in FIG. 1. For example, FIG. 2 shows a custom discount manager display 200, where the PMO system 100 may allow a PMO user 138 to enter a proposed client discount percentage and/or to re-zone and/or re-rate a 3PL client's 140 invoice data for one or more distribution center origin locations, and may further allow the PMO user 138 to select and enter the 3PL client's 140 discount levels by, for example but not limited to, level of service, postal packages, minimum, weight, carrier accessorial, etc. FIG. 3 shows a custom discount manager display 205, which may show for example the 3PL client's 140 savings, and may further show the 3PL service provider's 110 income generated from a specific service level margin management (income based on the particular service and discount level). In custom discount manager display 205 of FIG. 3, a line 206 may indicate an example of the 3PL client's 140 savings that may be offered and a line 207 may indicate an example of the 3PL service provider's 110 income that may be generated at this savings offer.

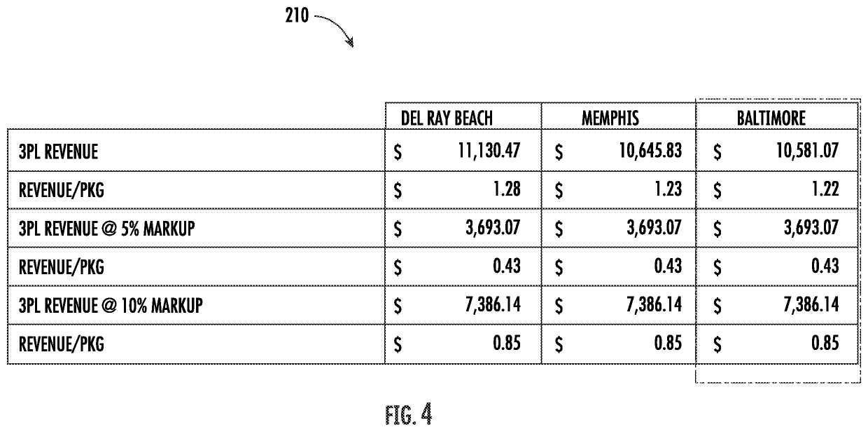

FIG. 4 shows example data 210 with various revenue models comparing various percent markups, i.e., percent markups to the 3PL service provider's 110 shipping rate that a shipping carrier 142 would charge the 3PL service provider 110 for the same shipping service.

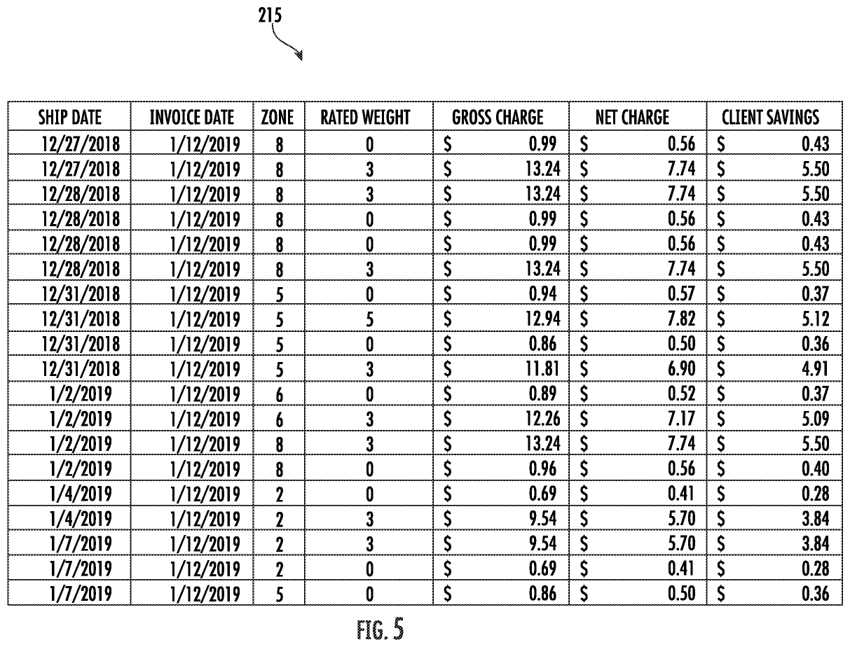

FIG. 5 shows an example of a detailed client report 215, the client detail may, for example, reflect discounts offered/provided by the 3PL service provider 110. The discount being based on, for example, a percentage of the difference between what the 3PL client 140 would have paid the shipping carrier 142 versus what the shipping carrier 142 charges the 3PL service provider 110 for the same shipping service.

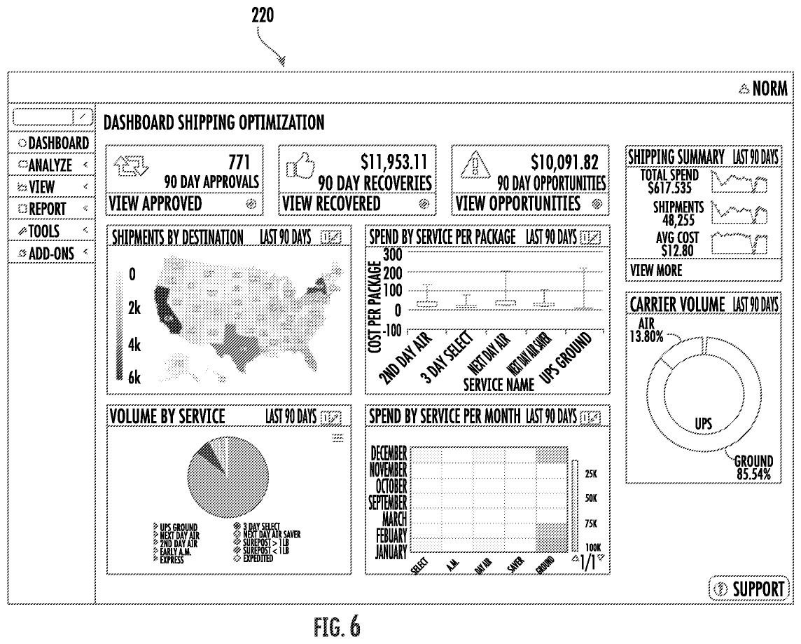

FIG. 6 shows an example of a 3PL client audit dashboard 220, which may provide 3PL clients 140 access to various business information and analytics related to their shipping costs provided by the PMO system 100. In one example, 3PL client audit dashboard 220 uses the data from the PMO system 100 to generate the various business information and analytics for the 3PL client to access. The information displayed in the 3PL client audit dashboard 220 utilizes, for example, the values calculated by PMO system 100 based on the discount structure (discounted shipping rates) provided by the 3PL service provider 110 to the 3PL client 140, and may further correctly rate any credits it displays, not just the initial charges. In one example, 3PL client audit dashboard 220 may be provided as a separate add on application.

The information shown in detailed client report 215 of FIG. 5 may be an example of a portion of a carrier invoice. This detailed reporting for each client may reflect discounts offered by 3PL service provider 110. A client report that may include the information shown in detailed client reporting display 215 along with a carrier data file (e.g., information in shipping rates data 134) may be provided to 3PL service provider 110. Detailed client report 215 may further include carrier, carrier account number, tracking number, carrier price group, and/or other related data up to and including all data elements provided in the carrier (e.g., shipping carrier 142) provided invoice.

Generally, the process flow of PMO system 100 may include one or more of the following:
(1) providing a pre-sales analysis screen (e.g., custom discount manager display 200 of FIG. 2) to establish the correct discount to offer a client;
(2) entering a unique discount profile for each client for each carrier;
(3) automatically downloading (e.g., each week) the 3PL company's parcel invoices;
(4) re-rating the invoice data to each client's rate based on the discount profile offered;
(5) generating reports of the client's per package pricing and forwarding them to the 3PL company; and
(6) providing client access to a Parcel Audit System for client-facing analytics tools (e.g., 3PL client audit dashboard 220 of FIG. 6).

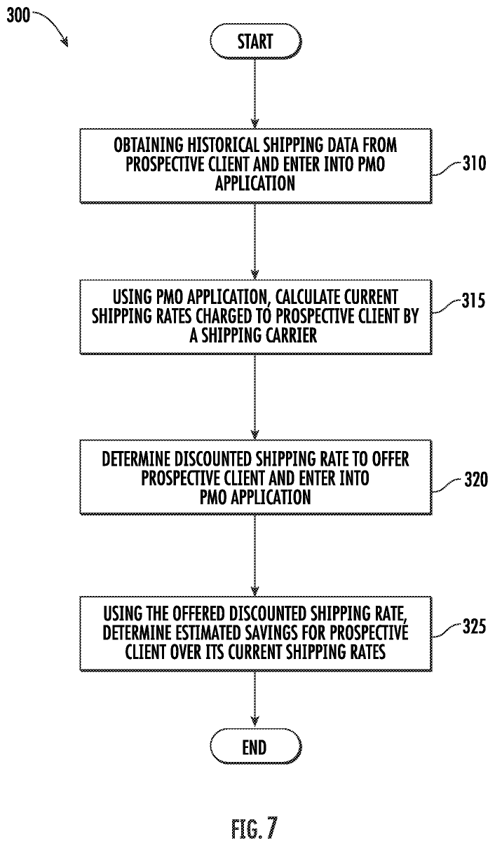

Referring now to FIG. 7 is a flow diagram of an example of a generalized method 300 of using the presently disclosed PMO system 100 for generating and optimizing discounted parcel shipping prices. Method 300 may represent the operation of PMO system 100 at a high level. Method 300 may include, but is not limited to, the following steps, and may be carried out in a different order.

At a step 310, historical shipping information is obtained for a prospective client and then entered into PMO application 122 of the presently disclosed PMO system 100. For example, historical shipping data (e.g., shipping details and costs) may be received from one of the 3PL clients 140, who is the prospective client, and/or a shipping carrier's published shipping rates. Then, this data may be entered into PMO application 122 and stored in client historical shipping data 130 at computing device 120.

At a step 315, using PMO application 122, the current shipping rates charged to the prospective client by a shipping carrier is calculated, i.e., what the prospective client was/is paying a shipping carrier for shipping particular parcels. For example, using PMO application 122, the current shipping rates charged to the prospective 3PL client 140 by one or more of the shipping carriers 142 is calculated.

At a step 320, a discounted shipping rate to offer the prospective client is determined and then entered into the PMO application, i.e., by comparing what the prospective 3PL client 140 was/is paying the one or more of the shipping carriers 142 versus what the 3PL service provider 110 would pay for the same shipping service. For example, based on the information collected in steps 310 and 315, PMO user 138 determines a discounted shipping rate to offer the prospective 3PL client 140. Then, PMO user 138 enters this discounted shipping rate into PMO application 122.

At a step 325, using the offered discounted shipping rate, the estimated savings for prospective client over its current shipping rates is determined. For example, PMO application 122 uses the offered discounted shipping rate to calculate the estimated savings for the prospective 3PL client 140 over its current shipping rate. The PMO application 122, for example, may use the offered/proposed discounted rates to recalculate the rates paid by the prospective 3PL client's 140 for its historic shipments as though they had shipped from one or more different facilities than they originally shipped from and as though they had all shipped at the discounted rate(s) offered by the 3PL service provider 110.

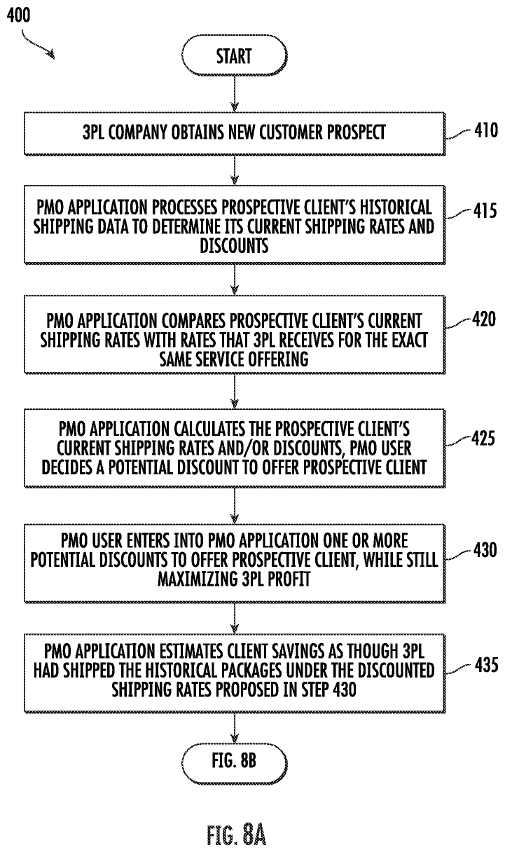

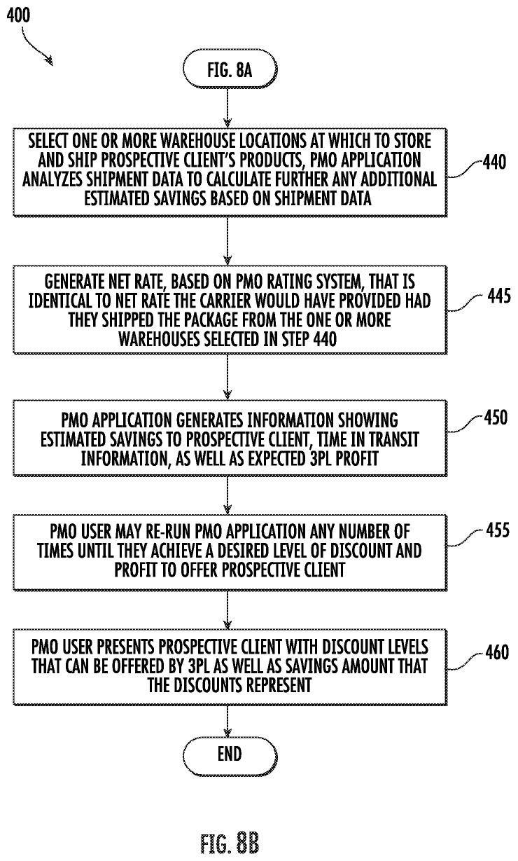

Referring now to FIG. 8A and FIG. 8B is a flow diagram of an example of a method 400 of using the presently disclosed PMO system 100 for optimizing discounted parcel shipping prices. Method 400 may represent the operation of PMO system 100 at a more detailed level as compared with method 300 of FIG. 7. Method 400 may include, but is not limited to, the following steps, and may be carried out in a different order.

At a step 410, the 3PL company may receive a new customer prospect. For example, in PMO system 100, 3PL service provider 110 may receive a new client prospect among, for example, the 3PL clients 140.

At a step 415, the PMO application may process the prospective client's historical shipping data to determine its current shipping discounts. For example, historical shipping data may be obtained from the prospective 3PL client 140, or may be obtained elsewhere (e.g., published shipping rates), and then entered into PMO application 122 and stored in client historical shipping data 130 at computing device 120. Client historical shipping data 130 may include information about the prospective 3PL client's 140 shipments over a period of time, for example, in the range of about a week to about a year of past shipments, or some other time period. In one non-limiting example, about thirteen (13) weeks of historical shipment data may be provided and stored in client historical shipping data 130. Once the client historical shipping data 130 is stored, the PMO application 122 may then process the client historical shipping data 130 to determine the prospective 3PL client's 140 current shipping rates and discounts.

At a step 420, the PMO application may compare the prospective client's current shipping rates with rates that the 3PL company receives for the same or comparable service offering. For example, using the information in the client historical shipping data 130, PMO application 122 compares the current shipping rates of prospective 3PL client 140 directly with the rates that 3PL service provider 110 may be charged for the same services by a carrier (e.g., shipping carriers 142). PMO application 122 may also estimate the annual amount that the prospective 3PL client 140 spends for these shipping services. The current shipping rates and/or discounts and annual spending is a non-limiting example of information that may be stored in client PMO data 132.

At a step 425, once the PMO application calculates the prospective client's current shipping rates and/or discounts, the PMO user decides a potential discount to offer the prospective client. For example, a PMO user 138 (e.g., a sales associate) may use the calculated prospective 3PL client's 140 shipping rates, and optionally the estimated annual spend, to determine a discounted rate to propose to the prospective client, to, for example, try and win the prospective client's business. For example, the discounted rate may be determined as a rate between the rate the prospective client is currently paying and the rate that 3PL service provider 110 may pay for the same shipping services. That is, the proposed discounted rate may preferably be (1) not greater than the prospective 3PL client's 140 current shipping rate, and (2) equal to or greater than the shipping rate that 3PL service provider 110 may be charged for the same services by a carrier. Further, there may be circumstances in which 3PL service provider 110 does not use the same carrier as the prospective 3PL client 140 or circumstances in which the 3PL client 140 may like to use a different carrier. In this example, PMO application 122 allows for the entry of an alternative carrier against which to calculate the rate discounts and does not require a prospective 3PL client 140 to stay with their existing carrier.

At a step 430, the PMO user enters into the PMO application one or more potential discounts to offer the prospective client in order to win their business, while still maximizing 3PL profit. For example, PMO user 138 may enter into PMO application 122 proposed discount rate data to charge the prospective Client 140 in an attempt to win their business, while still maximizing profit for 3PL service provider 110. The proposed discount rate data may be another example of information that may be stored in client PMO data 132.

At a step 435, the PMO application estimates the client savings as though the 3PL company had shipped the historical packages under the discounted shipping rates proposed in step 430. For example, PMO application 122 analyzes the proposed discount rate data proposed in step 430 to calculate an estimated savings that the prospective 3PL client 140 may realize by using PMO system 100 of 3PL service provider 110. The estimated savings may be another example of information that may be stored in client PMO data 132.

At a step 440, one or more warehouse locations at which to store and ship the prospective client's products may be selected, then the PMO application analyzes shipment data to calculate further any additional estimated savings based on the shipment data. For example, using PMO application 122, the PMO user 138 may select one or more warehouses at which to store and ship the prospective 3PL client's 140 products. Next, PMO application 122 may analyze the shipment data of the selected warehouses to calculate further any additional estimated savings based on the shipment data (e.g., geographic location, etc.). Any additional estimated savings may be another example of information that may be stored in client PMO data 132.

More specifically, to generate the estimated savings, the PMO user 138 may select one or more of 3PL service provider's 110 warehouse locations where the prospective 3PL client's 140 products may be located. Once the one or more warehouses are selected, the PMO user 138 may use the PMO application 122 to recalculate the prospective 3PL client's 140 rates for each of the historical packages to reflect the correct zone(s) for each of the selected warehouses. Further, if the prospective 3PL client 140 is changing carriers (and/or level of service), then the service/shipping information for the historical shipment data will be updated to reflect the corresponding carrier change (and/or level of service).

At a step 445, using the stored data the system creates a highly accurate rating system of the PMO application, using its rating system, generates a net rate that is identical/near identical to the net rate the carrier would have provided had they shipped the package from the one or more warehouses selected in step 440. For example, using the rating system of PMO application 122, a net rate is generated that is identical/near identical to the net rate the shipping carrier 142 would have provided had they shipped the package from the one or more warehouses selected in step 440. More specifically, PMO application 122 may use the rating system to take specific package characteristics, along with the desired discounts off of a carrier's published shipping charges and generate a net rate that is identical/near identical to the net rate the carrier would have provided had the carrier shipped the package from the one or more warehouses selected in step 440.

At a step 450, the PMO application may generate information showing an estimated savings to the (e.g., as a discount as compared to what the prospective client historically would have paid), time in transit information, and may further generate an expected 3PL profit. PMO application 122 may generate information showing, for example but not limited to, the estimated savings to the prospective 3PL client 140, time in transit information, expected profit for the 3PL service provider 110. More specifically, PMO application 122 may use the data to generate, for example, a table showing an estimated saving to the prospective 3PL client 140 (e.g., line 206 of custom discount manager display 205 of FIG. 3), and may further show the average number of days of transit the package(s) would have taken to be delivered, as well as the amount of profit 3PL service provider 110 would receive (e.g., line 207 of custom discount manager display 205 of FIG. 3), from the shipment had the prospective 3PL client 140 used its services. The 3PL estimated profit for the prospective 3PL client 140 may be another example of information that may be stored in client PMO data 132.

At a step 455, the PMO user may re-run the PMO application any number of times against the 3PL client's 140 historical shipping data until they achieve a level of discount and profit desired or believed necessary to win the prospective client's business. For example, the PMO user 138 may re-run PMO application 122 against the 3PL client's 140 (or perspective client's) historical shipping data 130 any number of times, until they achieve a level of discount and profit desired or believed necessary to win the prospective 3PL client's 140 business. More specifically, the PMO user 138 may update PMO application 122 with proposed discount rates offered to the 3PL client's 140/prospective client, and then PMO application 122 may re-run the calculations to determine savings level(s) and/or profit level(s) based on the offered discount rates. The PMO user 138 may run PMO application 122 with updated shipping rates, and/or other data, e.g., shipping location, level of shipping service, shipping carrier, etc., until a satisfactory rate is determined.

At a step 460, the PMO user may present the prospective client with a discount level that can be offered by the 3PL company and also presents the savings amount that the discounts represent. In one example, the discount is presented to the client/perspective client as a percent discount off of what the client/perspective client historically has or would pay the shipping carrier the same shipping service. For example, the PMO user 138 may present the prospective 3PL client 140 with a discount level that can be offered by 3PL service provider 110, and may also present the savings amount that the discounts represent, e.g., as percent mark down from the shipping carrier's historically charged or published rates. More specifically, the PMO user 138 may present prospective 3PL client 140 with the calculated discount rate level, and may further provide the prospective 3PL client 140 with, for example, an estimated yearly savings based on the proposed discounted rate. The final/agreed-upon shipping rate and estimated yearly savings for this client may be another example of information that may be stored in client PMO data 132.

The PMO system 100 may further provide a 3PL client 140 with access to the 3PL client audit dashboard 220, which may provide the 3PL client 140 a client facing analytics tools, for example providing a spend trend dashboard that may provide the 3PL client 140 remote access to business intelligence related to their shipping costs and logistics.

One benefit of PMO system 100 and methods 300 and 400 is that the proposed discounted rate(s) is presented to the prospective client as a discount off of the carrier's historically charged or published rates rather than as a mark-up of the 3PL service provider's 110 discounted rate from the shipping carrier 142. Using PMO system 100 and methods 300 and 400, 3PL service provider 110 does not need to disclose the rates that the carrier actual charges the 3PL service provider 110. By presenting the discounted rate as a discount off of the shipping carrier's 142 historically charged or published rates, rather than as a markup of the rates the shipping carrier 142 charges the 3PL service provider 110, the prospect client receives a positive message that it will receive better discounts using the 3PL service provider 110 than it would working directly with a shipping carrier 142, or potentially with other 3PL service providers that show their rates as a mark-up of the 3PL service provider's discounted rate from the shipping carrier 142.

Another benefit of PMO system 100 and methods 300 and 400 is that PMO system 100 may be utilized to generate 3PL client invoices. In this regard, PMO application 122 may be used to generate an invoice using the data entered for each client to generate an invoice that shows the shipping details and the price charged. The shipping details may contain information, such as products shipped, warehouse shipped from, located shipped to, shipping date, and time spent in transport. The price charged may also show a typical courier fee plus the discount offered to give a total shipping fee. The total shipping fee may include the fee paid by 3PL service provider 110 to the shipping carrier 142, plus any additional markup. Any additional handling fee may be included as part of the shipping fee or shown separate. The advantage of this invoice is that the 3PL client 140 receives an invoice showing a discount over published shipping rates of the shipping carrier 142, without providing exact details as to the amount of the 3PL service provider's 110 markup to the amount of the shipping rate paid by 3PL service provider 110 to the shipping carrier 142.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A system for generating discounted parcel shipping rates, comprising:
a. at least one computing device capable of processing program instructions; and
b. at least one storage device operable coupled to the at least one computing device, the at least one storage device including program instructions that, when executed by the at least one computing device cause the at least one computing device to:
i. receive historical shipping data of a potential or current client of a logistics service provider;
ii. determine at least one historical shipping rate for one or more historical parcel shipments charged to the potential or current client by one or more shipping carriers based on the received historical shipping data;
iii. compare the at least one determined historical shipping rate to a discounted shipping rate charged to the logistics service provider by the one or more shipping carriers for a same or comparable shipping service; and
iv. determine a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service.

2. The system of claim 1, wherein the computing device is further configured to determine an estimated savings over a period of time for the potential or current client over the at least one determined historical shipping rate based on the determined potential or current client discounted shipping rate.

3. The system of claim 1, wherein the potential or current client discounted shipping rate is less than the at least one determined potential or current client historical shipping rate and greater than or equal to the discounted shipping rate charged to the logistics service provider by the one or more shipping carriers for the same or comparable shipping service.

4. The system of claim 1, wherein the at least one storage device further comprises data related to one or more of current clients, potential clients, shipping rate data, shipping carriers, shipment data, and the logistic service provider.

5. The system of claim 1, wherein one or more of the at least one computing device comprises a user interface, wherein the system is accessed by either or both of the potential or current client and logistics service provider via the user interface, and wherein the potential or current client accesses a client side of the system and the logistics service provider accesses a service provider side of the system.

6. The system of claim 1, wherein the at least one computing device is connected via a network to one or more of one or more potential or current clients, one or more shipping carriers, and one or more logistic service providers.

7. The system of claim 1, wherein the logistics service provider comprises a fulfillment provider or any other entity that provides third-party logistics services.

8. The system of claim 1, wherein the determined potential or current client discounted shipping rate may be further based on any one or more of shipping location, shipping carrier, and level of shipping service.

9. The system of claim 1, wherein the offered potential or current client discounted shipping rate is represented to the potential or current client as a discounted rate relative to the determined potential or current client historical shipping rate or a published shipping rate of one or more shipping carriers.

10. The system of claim 1, wherein the computing device is further configured to generate a client invoice for shipping one or more parcels, and wherein the client invoice shows a shipping rate as a discounted shipping rate over the determined historical shipping rate or a published shipping rate of one or more shipping carriers, and further wherein an amount of the shipping rate actually paid by the logistics service provide to the shipping carrier for shipping the one or more parcels is not shown.

11. The system of claim 1, wherein the historical shipping data comprises cost data for one or more historical parcel shipments charged to the potential or current client by one or more shipping carriers.

12. The system of claim 1, wherein the computing device is further configured to generate a client report for a client of the logistics service provider, wherein the client report comprises one or more of shipping details, costs, and savings for one or more parcels shipped using the logistics service provider over a defined period of time.

13. The system of claim 1, wherein the computing device is further configured to generate a client side dashboard accessible by a client of the logistics service provider, wherein the client side dashboard allows client access to business information and analytics related to the client's shipping costs for logistic services provided by the logistics service provider, and wherein the business information and analytics data utilizes the determined potential or current client discounted shipping rate data.

14. The system of claim 13, wherein the client side dashboard is a separate add on application and is configured to access the at least one storage device to access the applicable data stored therein to generate the client side dashboard with the client's business information and analytics.

15. The system of claim 1, wherein the historical shipping data comprises published shipping rates of one or more shipping carriers.

16. A method for generating discounted parcel shipping rates, comprising:
a. receiving historical shipping data of a potential or current client of a logistics service provider;
b. determining at least one historical shipping rate for one or more historical parcel shipments charged to the potential or current client by one or more shipping carriers based on the received historical shipping data;
c. comparing the at least one determined historical shipping rate to a discounted shipping rate charged to the logistics service provider by the one or more shipping carriers for a same or comparable shipping service; and
d. determining a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service.

17. The method of claim 16, further comprising determining an estimated cost over a period of time for the potential or current client based on the at least one determined historical shipping rate.

18. The method of claim 16, further comprising determining an estimated savings over a period of time for the potential or current client over the at least one determined historical shipping rate based on the determined potential or current client discounted shipping rate.

19. The method of claim 16, wherein the potential or current client discounted shipping rate is less than the at least one determined potential or current client historical shipping rate and greater than or equal to the discounted shipping rate charged to the logistics service provider by the one or more shipping carriers for the same or comparable shipping service.

20. The method of claim 16, wherein determining potential or current client discounted shipping rate may be further based on any one or more of shipping location, shipping carrier, and level of shipping service.

21. The method of claim 16, wherein the offered potential or current client discounted shipping rate is represented to the potential or current client as a discounted rate relative to the determined potential or current client historical shipping rate.

22. The method of claim 16, further comprising generating a client invoice for shipping one or more parcels, and wherein the client invoice shows a shipping rate as a discounted shipping rate over the determined historical shipping rate or a published shipping rate of the shipping carrier, and further wherein an amount of the shipping rate actually paid by the logistics service provide to the shipping carrier for shipping the one or more parcels is not shown.

23. The method of claim 16, further comprising repeating at least step 12(d) one or more times until a desired optimized level of potential or current client discounted shipping rate and logistics service provider margin is achieved.

24. A computer readable storage medium storing a program of instructions executable by a machine to perform a method for generating discounted parcel shipping rates to optimizing margins, the method comprising:
a. receiving historical shipping data of a potential or current client of a logistics service provider;
b. determining at least one historical shipping rate for one or more historical parcel shipments charged to the potential or current client by one or more shipping carriers based on the received historical shipping data;
c. comparing the at least one determined historical shipping rate to a discounted shipping rate charged to the logistics service provider by the one or more shipping carriers for a same or comparable shipping service; and
d. determining a potential or current client discounted shipping rate to offer the potential or current client based at least in part on the comparison of the at least one determined potential or current client historical shipping rate and the discounted shipping rate charged to the logistics service provider by the one or more shipping carriers for the same or comparable shipping service.
